(19) United States
(12) Patent Application Publication
(10) Pub. No.: US 2005/0116010 A1
(43) Pub. Date: Jun. 2, 2005

(54) Fibrous web and process for the production thereof

(76) Inventors: Lars Gronroos, Tampere (FI); Vesa Helanti, Lempaala (FI)

Correspondence Address: BAKER & DANIELS, 300 NORTH MERIDIAN STREET, SUITE 2700, INDIANAPOLIS, IN, 46204-1782, US

(21) Appl. No.: 10/509,291

(22) PCT Filed: Mar. 25, 2003
(86) PCT No.: PCT/FI03/00229

(30) Foreign Application Priority Data
Mar. 25, 2002 (FI) 20020566

(51) Int. Cl. B23K 1/00

(52) U.S. Cl. 228/101

(57) ABSTRACT

The invention relates to a fibrous web containing a filler and to a method for manufacturing the same. The fibrous web containing the filler comprises a substance, which is in a granular form and has a rotationally symmetrical shape and an inner part and a crust part, whereby the density of the inner part is lower than the crust part. The granule contains pigment particles that are interconnected by means of a binder. According to the invention, the fibrous web can be, for example, a paper, board or non-woven web. The fibrous web has a good tensile strength and good fire resistance properties.

The present invention relates to a filler and its use in the manufacture of a fibrous material. In particular, the invention relates to a fibrous web containing filler according to the preamble of Claim 1.

The invention also relates to the method according to the preamble of Claim 14 for manufacturing the fibrous web containing the filler, and the method according to the preamble of Claim 21 for improving the fire resistance properties of the fibrous web that has a good tensile strength.

Paper manufacture involves several, partly contradictory objects. Accordingly, the end product should have, among others, as good optical properties as possible, such as brightness, smoothness, stability, glaze and opacity. Fillers are used to improve these properties. As most fillers are cheaper than the raw fibrous material used in paper, the costs of raw material can also be reduced using fillers.

The conventional filling agents or fillers are powdery, fine-grained powders. They are manufactured from natural minerals or by synthetic means. Generally, fillers are divided into mineral fillers, special pigments and other fillers. The most common mineral fillers are kaolin, talc and calcium carbonate. Special pigments include structured kaolin, synthetic silicates, titanium dioxides, aluminium hydroxide and some organic pigments. Other fillers comprise, e.g., gypsum, satin white and barium and zinc sulphates.

The most common requirement for increasing the amount of filler in the papermaking industry are the price of the filler, which is lower than that of cellulose, and better non-transparency or opacity. The purpose is to make the fibrous web (e.g., paper) as non-transparent or opaque as possible by means of as thin a coating layer as possible. The paper must also have good mechanical properties, such as a good smoothness and high dry and wet strengths.

However, there are also disadvantages involved in using fillers. The filler that is used causes a deterioration of the mechanical properties of the end product, the strength in particular. According to a generally accepted rule in paper technology, the paper strength decreases by about two or three times the amount of added filler, when the cellulose in paper is replaced with filler, i.e., after adding 10% of filler into the paper, its strength is 20-30% lower than that of a paper of a corresponding weight that contains chemical pulp only. The particle size and shape of the filler have an impact on the decrease in strength; a large particle size does not decrease the strength as much as a small one.

The deterioration of the strength properties is not a consequence of the decrease in the amount of cellulose only. The filler addition reduces the amount of cellulose by 10%, so the decrease in strength resulting from this would only be 10%. The other 10 to 20% of the strength are mainly lost because of the adverse effect of the filler on the bonds between the cellulose fibres. The filler particles settle partly between the fibres, whereby the bonding of the fibres to one another by means of hydrogen bonds, for example, decreases. This contributes to the deterioration of the strength properties.

It should also be mentioned that, when massive particles are used as filler, there is the special problem that the weight of the filled or coated product increases because of the high density of the massive particles. This fact may have an adverse effect on the use or the economy of the product. If it were possible to provide the same properties using a lower-density pigment, it would be of great economic benefit.

The purpose of this invention is to remove the disadvantages that are related to the deterioration of the strength properties.

The invention is based on the idea that in addition to or instead of conventional powdery fillers, a combination product is used, comprising pigment particles and a binder that interlinks them. The interlinked pigment particles form a pigment-binder structure granule. This granule has a rotationally symmetrical shape and it has an inner part and a crust part, whereby the density of the inner part is lower than the crust. In addition to the binder and the pigments, the structure possibly also includes additives. We have surprisingly discovered that such a combination product settles in the spaces between the fibres of the fibrous web, so that the bonds between the fibres are not disturbed and the strength inherent to the structure remains.

The invention is characterized in that at least part, not less than 3% by weight of the amount of filler in the manufacture of the fibrous web is replaced with such particle granules.

To be more precise, the fibrous web according to the invention is characterized in that, which is presented in the characterizing part of Claim 1. The method according to the invention for manufacturing the fibrous web that has a good tensile strength is characterized in that, which is presented in the characterizing part of Claim 14, and the method according to the invention for improving the fire resistance properties of the fibrous web is characterized in that, which is presented in the characterizing part of Claim 21.

The invention provides considerable advantages. By using the filler according to the invention, the costs of raw material can be decreased without deteriorating the strength properties, and even improve the mechanical properties of the end product. Another considerable advantage provided by the invention is that, as the density of the granule according to the invention is lower than that of the massive particles normally used, the weight of the end product will not grow to an unreasonable extent.

The other features and advantages of the invention are presented in the following detailed description and the related application example.

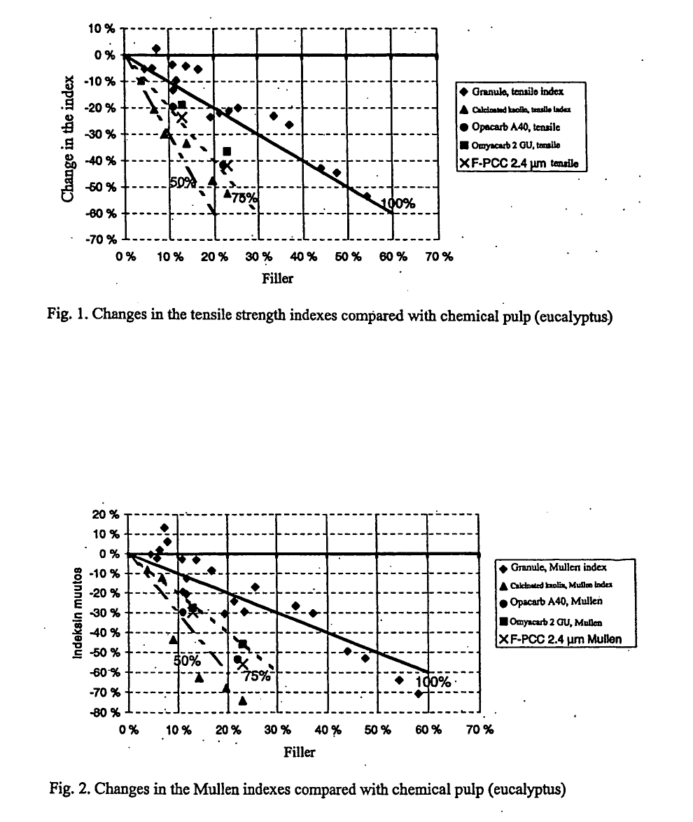

FIG. 1 is a graphical representation of a change in the tensile strength indexes as a function of the amount of filler.

FIG. 2 is a graphical representation of a change in the Mullen indexes as a function of the amount of filler.

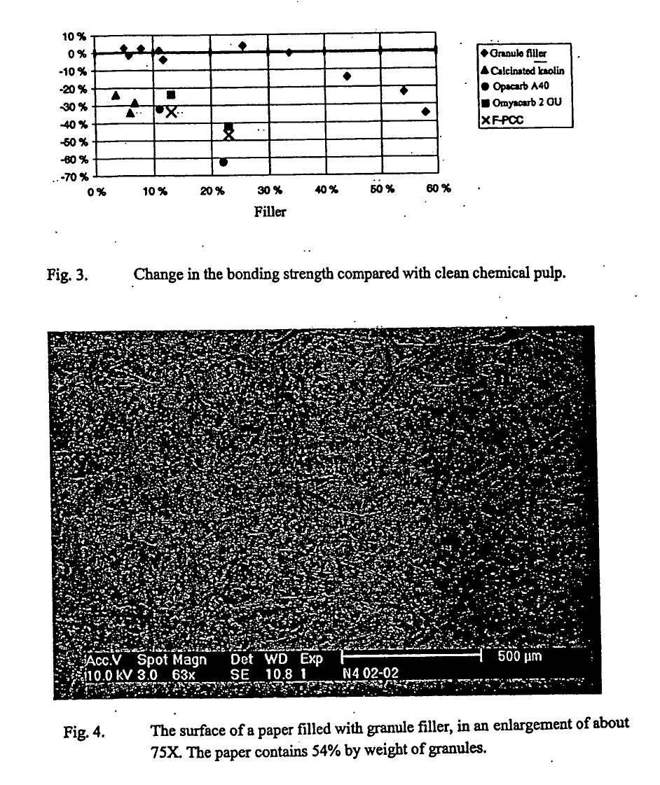

FIG. 3 is a graphical representation of a change in the bonding strength as a function of the amount of filler.

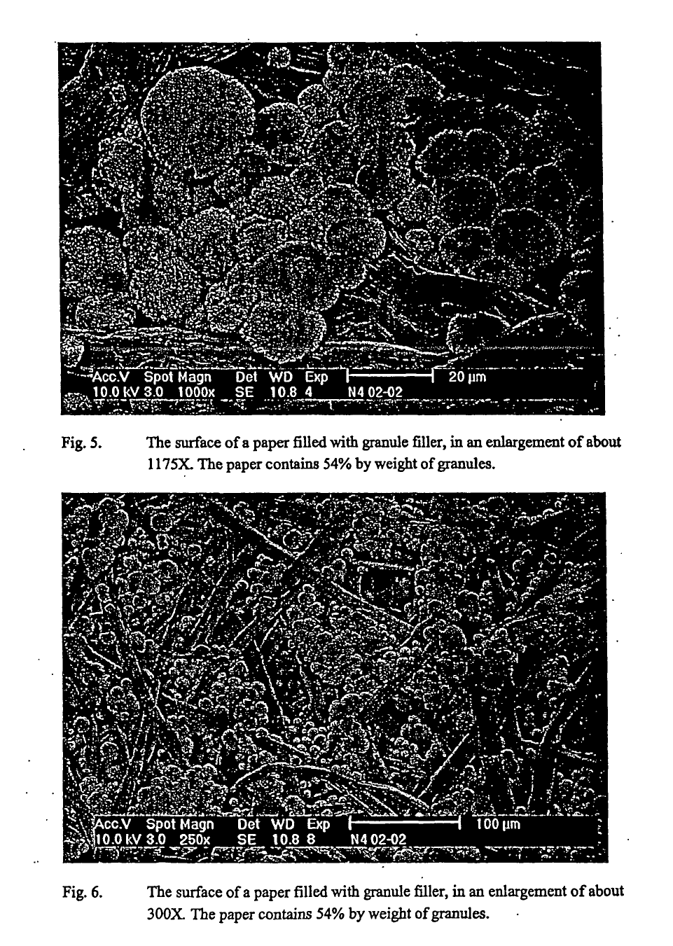

FIGS. 4, 5 and 6 are microscopic images of the surface of a paper filled with the granule filler, the enlargements being about 75×, 1175× and 300×. The paper in the figures contains 54% by weight of the granule.

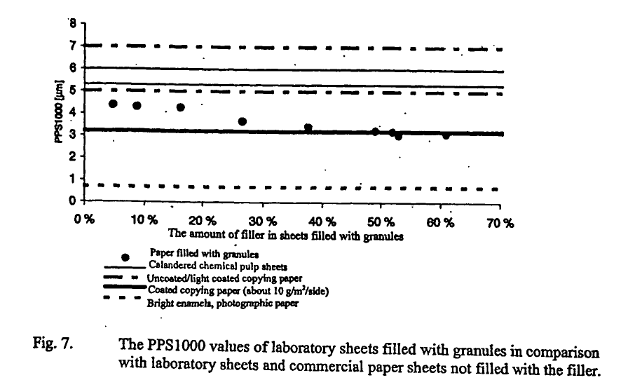

FIG. 7 is a graphical representation of the PPS1000 values of laboratory sheets filled with granules, compared with laboratory sheets and commercial sheets of paper not containing any filler.

Generally, the size of the particle granules according to the invention is 1-200 μm, preferably 1-100 μm, and most preferably about 5-20 μm. In the manufacturing process, the size of the granules can be adjusted within the permissible limits of the process.

The filler element, which is the object of the invention, consists of the following components:
pigment,
filler, a synthetic filler in the form of an emulsion in particular,
water
functional additives that facilitate the process or provide special properties.

Virtually, all known, commonly used pigments and their mixtures can be used in the invention. The common pigments include, e.g., mineral pigments. The mineral pigments include, e.g., kaolin, ground or precipitated calcium carbonates, titanium dioxide and silicate-based pigments. At least 60% of the pigment used preferably has a particle size of less than 20 μm.

Various synthetic binders in the form of an emulsion, such as styrene/butadiene latex or polyvinyl acetate polyacrylate-based latexes can preferably be used as the binder; however, not being limited to the examples mentioned herein only.

The possible additives can, for example, improve the rheology of the compound or change its surface tension, or provide the final product with special properties, such as surface strength, electrical conductibility, or affect the absorption of black. The use of additives is not limited to the examples mentioned only, but any commonly used functional additives can be used in the method.

Spherical or otherwise rotationally symmetrical particle granules are produced by means of drying an aqueous slurry, which consists of the binder, a pigment and possible additives. In that case, the components mentioned above are first mixed together by means of effective mixing in order to provide as homogeneous a compound or suspension/dispersion as possible.

As regards the drying technique, spray drying is especially well suited for the manufacture of the granules according to the invention but, as is obvious to those skilled in the art, the drying methods are not limited to the spray drying only but other types of drying techniques can also be considered, as long as they can be used to produce the said granules. It is essential that very fine-grained drops can be formed in drying, drying apart from one another. The size of the drops should correspond to that of the desired pigment granules. Generally, the size of the drops is thus about 1.1 to 5 times that of the granules; typically, the size of the drop is about 1 to 300 μm, preferably 5 to 100 μm, and most preferably 50 μm at the maximum.

The source material pigments used in the invention consist of products that have different size particles. Segregation of pigments thus takes place inside the particle granules formed during drying. An inner part and a surrounding crust part are formed. Generally, the thickness of the crust part in the direction of the radius of the ball-structure is about 0.1 to 50%, preferably 0.1 to 10%, typically 0.5 to 2% of the radius of the granule.

As the inner part contains a greater number of rough particles than the crust part, the density of the pigment-binder structure is lower than the crust part. Generally, the density of the inner part is about 10 to 90%, preferably about 40 to 80% of the density of the crust part. Accordingly, as an example, we could say that when the particle granule consists of pigment particles with a density of about 2400 to 3100 kg/m³, the density of the inner part is about 1100 to 1500 kg/m³ and that of the crust part about 1700 to 2000 kg/m³. The pigments most frequently used have densities of 1500 to 7000 kg/m³, whereby the total density of the granule is 450 to 6300 kg/M³, the density of the inner part is 50 to 5700 kg/M³ and that of the crust part 600 to 6300 kg/m³. Normally, the inner part of the pigment-binder structure then contains rougher pigment particles in relation to the crust part. The porosity of the inner part is also higher than that of the crust part, its pore volume is usually about 15 to 70% by volume, preferably about 30 to 60%.

The inner part of the particle granule contains a lesser amount of binder than the surface part. Generally, about 55 to 95% by weight of the total amount of binder of the particle granule is located in the crust or surface part of the granule.

The particle granule contains about 1 to 30 weight fractions, preferably about 2 to 20 weight fractions of binder per 100 weight fractions of pigment particles. In that case, the crust part contains fine-grained pigment particles, such as metal silicate, metal sulphate or metal carbonate particles, which are bound to one another by means of a cross-linked binder, whereby they form a fine and flexible coat that covers the inner part.

The terms “pigment-binder structure” and “particle granule” are used as synonyms in the present invention, and they refer to a combination or an aggregate formed by the particles, the binder and possible additives, containing several particles that are interlinked. However, all the particles in the structure are not necessarily inter-linked, but the inner part of the structure that is poor in binder hardly ever has a very high mechanical strength.

The manufacture of the fibrous web according to the invention is started mixing the fibres and additives in water and diluting them to make a suitable consistency. The fibrous web can be a paper or board web, for example. The fibrous material used can either be softwood or hardwood cellulose or mechanical pulp. The fibrous web can exclusively consist of mechanical or chemical pulp, but both pulp grades are usually used in paper and the use of the paper determines the pulp structure. The granulated filler according to the invention is used as the filler either alone or combined with other fillers. The amount of granulated filler according to the invention that is used is 10 to 100% by weight, preferably 50 to 100% by weight and more preferably 80 to 100% by weight of the total amount of filler. The other fillers in this context mainly refer to mineral fillers, such as kaolin, calcium carbonate and talc. The granule preferably contains the same filler as that, which in any case would be used in the fibrous web.

The pulp obtained by mixing the raw materials is called fibrous pulp and its consistence varies according to the fibrous product that is manufactured. Typically, the fibrous pulp contains 95% of water, and the amounts of fibre and additive are in the same proportion than in the finished fibrous product. Thus, 40 to 90% of the amount of solids is fibrous material, and 10 to 60% are additives and auxiliary substances (containing fillers).

This mixture is spread onto a moving water-transmitting plastic fabric, i.e., wire, wherein the fibrous web is formed, when the water exits. Water is removed from the fibrous pulp and the fibrous web by means of suction, compression and evaporation. Suction provides a dry content of about 20 percent. A dry content of about 45 percent is achieved, when the wet paper web is pressed between the machine felts and rolls. Final drying to a dry content of 90 to 95 percent is achieved, when water is removed from the web by means of hot cylinders and dryer felts.

When so desired, the quality and the properties of the fibrous web according to the invention can be changed either by means of a calander and/or a coating unit connected to the paper machine or a separate calander (glazing), wherein a coating slip is spread onto the surface of the paper. The paper can also be coated several times. After coating, the paper web is dried. The finished web is wound on a paper roll, which is cut into narrower rolls or sheets that are suitable for further processing.

The fibrous web according to the invention can also be a non-woven fibrous product. The non-woven fibrous product refers to plate, sheet or web structures, which are made up when fibres or filaments intertwine by means of mechanical, thermal or chemical bonding.

A surprising observation was made in connection with a test program testing the granules according to the invention as a filler of paper. Adding the granulated filler into a sheet of cellulose in laboratory tests according to the SCAN standards produced, for both the tensile strength and the bursting strength (FIGS. 1-3), strength values much higher than anticipated. In the figures, the sheet above the 100% line is stronger than what the chemical pulp contained by it would imply. The strength of the bonds between the cellulose fibres below the line is reduced; the 75% and 50% limits are marked in the figure.

Generally, the strength decreased, at a maximum, to the same extent as the reduction in the amount of chemical pulp required but, in addition, there was obvious evidence of the strength being maintained even above this level. The graphs indicate that the granule filler does not weaken the bonds between the cellulose fibres. At the points above the 100% line of the tensile index and the Mullen index, the granule has actually participated in making the sheet strong, i.e., the effect is quite the contrary to using conventional fillers.

The invention includes an embodiment, according to which 3 to 30% by weight of the filler in a granule form are added to the fibrous web. In that case, the bonding strength of the fibrous web is essentially the same as that of a corresponding fibrous web containing no filler. The observation that the bonding strength remains the same as high as up to a 30% degree of fullness is also surprising; it is actually the bonding strength, which shows the greatest differences compared with prior art. In other words, it was discovered that the granulated filler was capable of strengthening the paper. Therefore, the invention comprises the use of the granule as the filler of the fibrous web to produce a product that has a good bonding strength.

The invention also comprises an embodiment, wherein the fibrous web contains over 30% by weight, especially at least 35% by weight of filler in a granule form. As indicated by the example below, we have been able to establish that, with these filler contents, the invention provides a fibrous web, such as a paper or board web, the smoothness of which without a coating layer corresponds to the smoothness of a coated fibrous web that contains conventional filler. When measured by means of the PPS1000 test, the level of smoothness is 2.5 to 3.5. The surface thus obtained has smoothness similar to that of a paper or board that is typically coated with 10 g of coating per side. Because of the invention, it is thus possible to considerably reduce the amount of coating. Thus, the invention provides a new use, wherein the disclosed granule is used in an amount of over 30% by weight for filling the fibrous web to produce a smooth printing surface.

When using both granule fillers and conventional fillers, the paper strength also depends on the binders used. Reference results obtained by means of conventional fillers are fairly normal and their behaviour is logical, indicating that the laboratory work is of good quality and the results repeatable. When a conventional filler, such as calcinated kaolin, is used as reference material, an addition of 10% reduces the tensile strength of a laboratory sheet by about 20 to 30% according to the particle size of the filler, as was expected. When the sheet contains, as the filler, a corresponding amount of granulated filler, the decrease in strength is 5 to 10% only.

The measured strength values indicate that the filler according to the invention can be used with a content of the same size as in conventional technology, and a considerably better strength can be achieved. Alternatively, the amount of filler according to the invention can be up to threefold compared to conventional technology, while the strength remains the same.

The advantageous effect of the granulated filler on the strength can mainly be attributed to two factors. The particle size of the granulated filler (φ1 to 100 μm) and the rotationally symmetrical shape bring about that the granule is not likely to stay between the contact surfaces of two cellulose fibres, whereby the bonds between the cellulose fibres are not disturbed. Another factor is that the filler granules are bound to the surrounding fibres and, through the contact points, can convey stresses between the fibres.

In addition to the good strength values, it was observed that paper filled with the granule filler had a surface that resembled light coated paper after calandering (FIGS. 4-6). When thermoplastic binder is used, the granule is plastically deformed under the combined effect of heat and pressure. The granules in the surface layer of the paper are deformed into a plate-like shape according to the paper surface. Accordingly, paper blended with a higher granule filler content produces a base paper with a higher-quality surface for coating, for example, and the need for coating decreases. With a filler content of as little as over 20%, the surface quality of the paper is improved so that the need for coating decreases.

The amount of granulated filler that was added in the tests was nearly 60 percent by weight at the most, and increasing the amount by 5 to 10 percent, or even 20 percent, did not seem to cause any difficulties. When a conventional reference pigment was used, the manufacture of the sheet became very difficult upon approaching a filler content of 30 percent by weight.

When the filler in a granule form according to the invention is used as filler, better fire resistance properties are accomplished than when using conventional fillers. This characteristic is based on the fact that, when calcium carbonate-based granules are used while the temperature rises to over 600°, the carbonate decomposes, releasing carbon dioxide and binding heat considerably, both of them fire-preventing properties. As a rule, mineral fillers impede combustion, and the possibility to include in the material a greater amount of granulated filler than conventional fillers improves the fire resistance.

The following examples describe the manufacture and the use of the granule filler, and the preparation of reference samples.

### EXAMPLE 1

### Manufacture of the Granule Filler

The pigment that was to be granulated was elutriated to make a slurry with a dry content of 50% by weight, and a 0.2% by weight dispersing agent called Dispex N40 was used in the elutriation.

Any inorganic powder with a particle size of a few micrometers at the most can be used as the pigment. In the example, a fine-grained PCC was used, which is commercially available, among others, by the trade names of Multifex-MM, Ultra-Pflex, Super-Pflex, Opacarb A40, Jetcoat and Albafil, all manufactured by SMI, or the Opti-Cal coating PCCs that are manufactured by Omya.

Acrylate latex was mixed with the pigment slurry to serve as the binder. In the example, the portion of latex in the granule's dry content is 7% by weight.

The slurry containing the pigment and the binder is spray dried. In the example, a laboratory spray drier of the Mobile Minor type is used, which is manufactured by Niro and has the following running parameters:
Feeding rate of slurry 50 ml/min
Rotational speed of the atomizer about 25000 rotations per minute
Temperature of drying air 200 to 250° C.
Temperature of out-coming air and granules about 110° C.

### EXAMPLE 2

### Use of the Granule Filler as a Filler

Cellulose, a 100% eucalyptus, was soaked and ground for 30 min in a Valley hollander beater in accordance with SCAN-C 25:76. The average length of the ground fibre, weighted by the length, was about 0.84 mm, and the amount of fines in the chemical pulp, based on weighting by the length, was 2.1% in accordance with a FiberLab measurement.

The granules were elutriated in water to provide a dry content of 10% by weight; and neither dispersing agents nor additives were used.

Ground cellulose and filler slurry were mixed with water so that a dry content of about 2.4 g/l was obtained for the pulp, when the basis weight of the sheet to be manufactured was 80 g/m², and the desired granule content in sheets manufactured by a fresh water sheet machine was 20%. In that case, the filler content of the pulp was about 26%, the filler retention about 70%. The amounts of compounds for the various filler contents and single sheet thicknesses were changed accordingly. A set of clean chemical pulp sheets was also made of each chemical pulp batch for reference.

A two-component retention agent was mixed with the pulp. First, cationic starch in a 2% solution was added in an amount of 0.5% of dry matter. After thorough mixing, 0.05% silica sol was added to serve as a cross-linking agent. This retention system is common practice in the paper industry.

Sheets were made of the pulp by means of equipment according to SCAN-C 26, the working methods were according to SCAN-C 26:76 and SCAN-M 5:76 with the exception that the sheets were dried by drum drying. Drum drying was necessary, because the sheets were calandered.

The dried sheets were conditioned for 24 h at a temperature of 25° C.; the relative humidity was 50%. The conditioned sheets were lightly calandered; the calandering temperature was about 65° C., after which they were conditioned again.

The tensile strength of the sheets was measured by means of a Lorentzen&Wettre Tensile Tester device, the bursting strength by means of a Lorentzen&Wettre Mullen device and the bonding strength by a Scott Internal Bond Model B testing apparatus, each device was employed in accordance with normal working methods and the instructions of the devices.

The tensile and Mullen indexes were calculated by dividing the measurement result by the respective basis weight of the sheet.

The reference graph shows a deviation of the index value from a clean chemical pulp sheet in each series of measurement. The value of the deviation is obtained as follows:
deviation=(X_{fn}−Xₚₛ)/Xₚₛ·100%,
wherein
X_{fn} is the measured index value of the filler-containing sample under examination
Xₚₛ is a sheet corresponding to the sample under examination and made from clean chemical pulp

### EXAMPLE 3

### Fillers used as Reference

Sheets were made of the commercial fillers that were used for reference by means of the same method as those made of the granule filler. The reference fillers are shown in Table 1.

TABLE 1

| Filler | Description |
|---|---|
| Omyacarb 2 GU | Rough GCC, particle size d₅₀ about |
| | 2.5 μm |
| F-PCC | Scalenohedric filler PCC, particle size |
| | d₅₀ about 2.4 μm |
| Alphatex | Calcinated kaolin d₅₀ about 0.7-0.9 μm |
| Opacarb A40 | Coating PCC d₅₀ about 0.4 μm |

The filler PCC had already been elutriated into a slurry of about 18% by weight, the GCC and the calcinated kaolin were elutriated without additives into a slurry of 10% by weight. Opacarb had also already been elutriated. When making the reference samples, the same retention agents and working methods were used as when using the granule fillers.

The mechanical properties of the reference samples were measured with the same instruments and the results were dealt with in the same way as when using the granule fillers.

### EXAMPLE 4

### Measurements of Surface Roughness

The surface roughness of sheets, which contained the granule filler and were made by means of a laboratory sheet mould, was measured using a Parker Print Surf device of the Messmer Büchel trademark, the type of the device being M590. The filler content of the measured sheets ranged between about 5% to about 61%, the basis weights were in the range of 63 to 90 g/m². For reference, corresponding chemical pulp sheets with no filler and various commercial paper grades were also measured.

The measured laboratory sheets were made of a 100% chemical birch pulp. All laboratory sheets had been calandered by a linear pressure of about 60 kN/m; the roll temperature had been about 65° C. The surfaces of the laboratory sheets that had been against the web were against the smooth metal roll, when calandering.

The roughness measurements were made using a pressure of 1 MPa for measuring (PPS 1000) and a soft background.

The results of the measurements are shown in FIG. 7. The results of the copying paper sheets and the sheets that contained nothing but chemical pulp are shown in the form of ranges of fluctuation; the values of coated paper showed less fluctuation, therefore, a typical value of theirs is presented. For the copying paper sheets, both sides have been taken into account, and for the single faced coated sheets, the coated sides only. As regards the laboratory sheets, the measured values of the side that was against the metal roll in calandering are shown.

According to these measurements, the PPS1000 standard of coated paper is achieved by a filler addition of about 35 to 40% when using the granule filler. The surface formed by the granules used has a microstructure similar to coated paper; therefore, the PPS1000 does not show a considerable change when adding the filler.

1. A fibrous web containing a filler, which is a substance in a granular form, having a rotationally symmetrical shape and an inner part and a crust part, whereby the density of the inner part is lower than the crust part, characterized in that
the density of the inner part is about 10 to 90% of that of the crust part, and
the amount of filler used is 3 to 60% of the amount of solids.

2. A fibrous web according to claim 1, characterized in that the density of the inner part of the filler granule is about 10 to 90%, preferably about 40 to 80% of that of the crust part.

3. A fibrous web according to claim 1, characterized in that the filler granule consists of pigment particles and a binder.

4. A fibrous web according to claim 1, characterized in that the density of the pigment particles is 1500 to 7000 kg/m³, preferably about 2000 to 3100 kg/m³.

5. A fibrous web according to claim 1, characterized in that the density of the filler granule is 400 to 6300 kg/M³, preferably 600 to 2800 kg/M³, whereby the density of the inner part is about 50 to 5700 kg/m³, preferably 700 to 1500 kg/M³, and the density of the crust part is about 600 to 6300 kg/M³, preferably 1700 to 2000 kg/M³.

6. A fibrous web according to claim 1, characterized in that the inner part of the filler granule contains rougher pigment particles in relation to the crust part.

7. A fibrous web according to claim 1, characterized in that the porosity of the inner part of the filler granule is higher than that of the crust part, whereby the pore volume of the inner part is 10 to 70% by volume, preferably about 30 to 60% by volume.

8. A fibrous web according to claim 1, characterized in that the crust part of the filler granule comprises metal silicate, metal sulphate or metal carbonate particles, which are bound to one another by means of a cross-linked binder, whereby they form a dense coat that surrounds the inner part.

9. A fibrous web according to claim 1, characterized in that the filler particles of the filler granule comprise any inorganic substance, for example, kaolins, ground or precipitated calcium carbonates.

10. A fibrous web according to claim 1, characterized in that the particle size (φ) of the granulated filler is 1 to 100 μm, preferably 5 to 50 μm.

11. A fibrous web according to claim 1, characterized in that the substance in the granular form is plastically deformable under the effect of pressure and/or temperature.

12. A fibrous web according to claim 1, characterized in containing 3 to 30% by weight of the filler in granular form, whereby the bonding strength of the fibrous web is essentially the same as that of a corresponding fibrous web that contains no filler.

13. A fibrous web according to claim 1, characterized in containing over 30% by weight of the filler in granular form.

14. A method for manufacturing a fibrous web, such as a board, paper or non-woven web containing a filler and having a good tensile strength, the method comprising the inclusion of the filler in the fibrous web, the filler being a substance in a granular form and having a rotationally symmetrical shape and an inner part and a crust part, and the density of the inner part being lower than the crust part, characterized in that the density of the inner part is about 10 to 90% of that of the crust part, and the amount of filler used is 3 to 60% of the amount of solids.

15. A method according to claim 14, characterized in that at least 10% by weight of the filler of the fibrous web consists of the granulated filler, whereby its tensile strength is at least 10% better than that of a corresponding fibrous web that contains a mineral pigment that is essentially fully ground.

16. A method according to claim 14, characterized in that a granulated filler is used, the particle size (φ) of which is 1 to 100 μm, preferably 5 to 50 μm.

17. A method according to claim 14, characterized in that the amount of granulated filler used is 3 to 60% of the web's dry weight.

18. A method according to claim 14, characterized in that the fibrous web containing the filler is coated with a coating composition.

19. A method according to claim 14, characterized in that to obtain a predefined level of opacity, the amount of coating pigment used is 30% smaller than when providing a corresponding level of opacity with a fibrous web that contains powdery mineral pigments.

20. A method according to claim 14, characterized in that the substance in the granular form is plastically deformable under the effect of pressure and/or temperature.

21. A method for improving the fire resistance properties of a fibrous web that contains a filler and has a good tensile strength, whereby the filler is a massive substance in a granular form, having a rotationally symmetrical shape and an inner part and a crust part, and the density of the inner part is lower than the crust part, characterized in that the density of the inner part is about 10 to 90% of that of the crust part, and the amount of filler used is 3 to 60% of the amount of dry matter.

22. A method according to claim 21, characterized in that the substance in the granular form forms at least 10% by weight of the filler of the fibrous web.

23. A method according to claim 21, characterized in that the substance in the granular form forms 50 to 100% of the filler of the fibrous web.

24. A method according to claim 21, characterized in that the substance in the granular form is plastically deformable under the effect of pressure and/or temperature.
